(19) United States
(12) Patent Application Publication
(10) Pub. No.: US 2005/0281499 A1
(43) Pub. Date: Dec. 22, 2005

(54) Oil outlet for rolling mill oil film bearing

(76) Inventors: Thomas Wojtkowski JR., Shrewsbury, MA (US); Armando S. Martins, Cumberland, RI (US); Earl S. Winslow JR., Grafton, MA (US); Peter N. Osgood, Upton, MA (US)

Correspondence Address: GAUTHIER & CONNORS, LLP, 225 FRANKLIN STREET, BOSTON, MA, 02110, US

(21) Appl. No.: 10/873,924

(22) Filed: Jun. 22, 2004

(51) Int. Cl. F16C 19/00

(52) U.S. Cl. 384/473

(57) ABSTRACT

An oil outlet is disclosed for a rolling mill oil film bearing in which a bushing is fixed within a chock. The bushing has an internal bearing surface surrounding a rotating journal surface of a roll. Oil is introduced into a gap between the journal and bearing surfaces, and the thus introduced oil is rotatably propelled by the rotating journal surface before escaping tangentially from opposite ends of the gap. The oil outlet comprises a cover defining a groove adjacent to an end of the gap. The groove is positioned and configured to receive oil escaping from the gap and to redirect the oil along a circular path. An exit passageway communicates with the groove and is arranged substantially tangentially with respect to the circular path to receive oil escaping from the groove.

### BACKGROUND OF THE INVENTION

1. Field of the Invention

This invention relates to oil film bearings of the type employed to rotatably support the journal surfaces of roll necks in a rolling mill.

2. Description of the Prior Art

In a typical rolling mill oil film bearing, the outer journal surface of the roll neck is surrounded by the inner bearing surface of a cylindrical bushing fixed within a chock. The journal and bearing surfaces are respectively dimensioned to define a gap therebetween. During operation of the mill, oil is introduced continuously into the gap, where it is rotatably propelled by the rotating journal surface into a hydrodynamically maintained film between the journal and bearing surfaces at the load zone of the bearing. The oil eventually escapes from opposite ends of the gap into a sump from which it is removed by gravity drains and recirculated back to the bearing after having been cooled and filtered.

Relatively large sumps and drainage lines must be provided to accommodate the volume of oil being circulated through the bearing. These large sumps and drainage lines contribute disadvantageously to the overall size and cost of the bearing.

The objective of the present invention is to provide a smaller more efficient and less costly system for removing oil from the bearing.

### SUMMARY OF THE INVENTION

The present invention stems from the discovery that the oil escapes tangentially from the gap between the journal and bearing surfaces with a velocity directly proportional to the rotational speed of the journal surface. In accordance with the present invention, at least one and preferably at both ends of the gap, a grooved cover redirects the tangentially escaping oil along a circular path leading to a tangential exit passageway. The velocity of the exiting oil is thus harnessed to effect a pumping action forcibly removing the exiting oil from the bearing. These and other features and advantages of the present invention will now be described in greater detail with reference to the accompanying drawings, wherein:

### BRIEF DESCRIPTION OF THE DRAWINGS

FIG. 1 is a longitudinal sectional view through a rolling mill oil film bearing embodying oil outlets in accordance with the present invention;

FIG. 2 is a cross sectional view taken along line 2-2 of FIG. 1;

FIG. 3 is an enlarged sectional view taken along line 3-3 of FIG. 2;

FIG. 4 is an enlarged partially broken away view of the encircled portion of FIG. 2; and

FIG. 5 and 6 are views similar to FIG. 3 showing alternative embodiments of the invention.

### DETAILED DESCRIPTION OF PREFERRED EMBODIMENTS

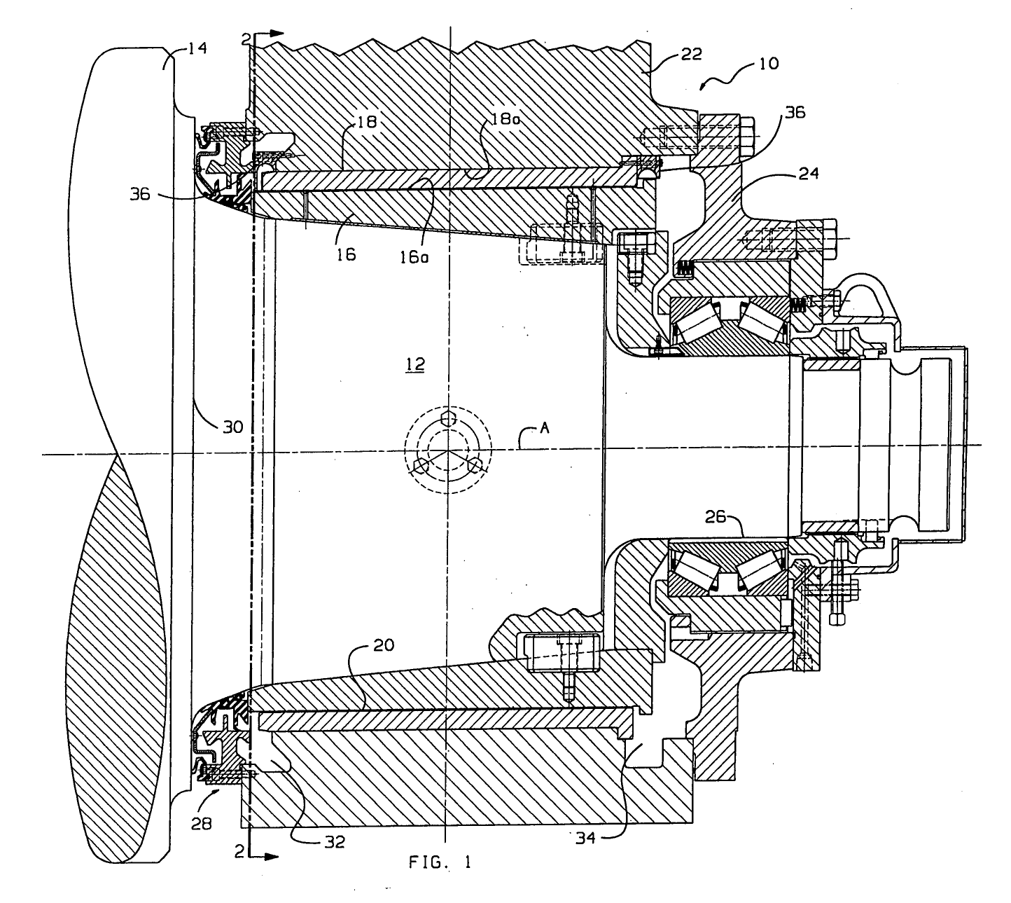

With reference initially to FIG. 1, a rolling mill oil film bearing 10 is shown mounted on the tapered neck section 12 of a roll 14. A sleeve 16 is received on and fixed relative to the tapered neck section 12. The exterior of the sleeve defines the journal surface 16a of the roll neck.

A bushing 18 has an internal bearing surface 18a surrounding and rotatably supporting the journal surface 16a. The bearing and journal surfaces are dimensioned respectively to define a gap 20 therebetween. The bushing 18 is contained by and fixed within a chock 22. The chock is closed at the outboard end by an enclosure 24 containing, inter alia, a thrust bearing 26. A seal assembly 28 is provided between a roll end face 30 and the inboard end of the chock 22.

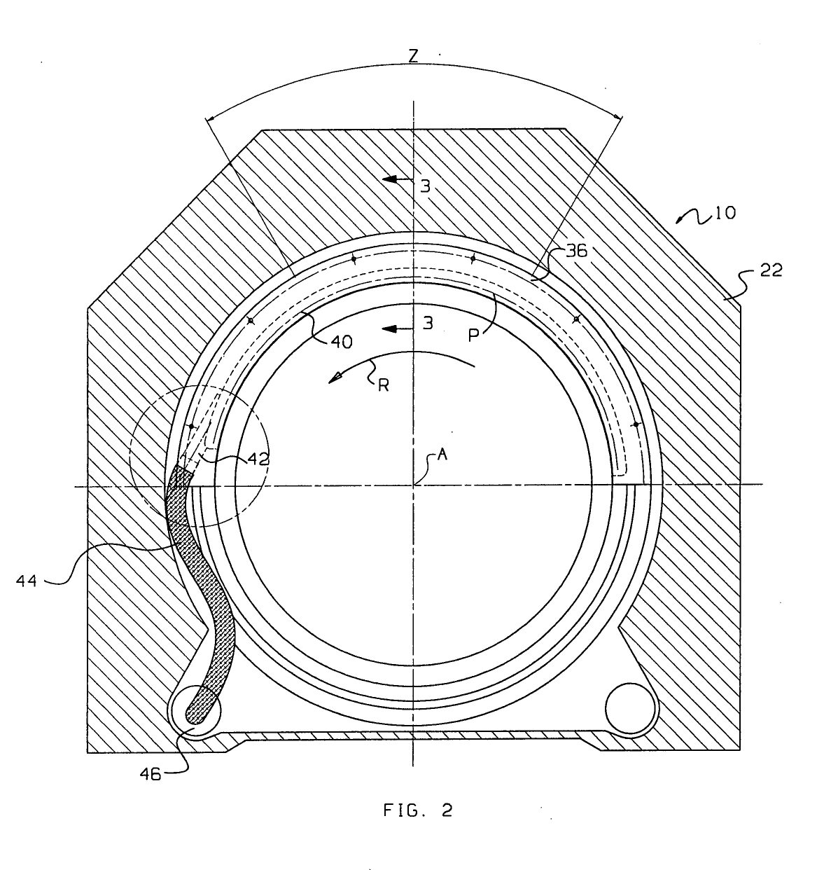

During operation of the mill, oil is introduced continuously to the gap 20 between the journal and bearing surfaces 16a, 18a. As shown in FIG. 2, the rotating journal surface 16a rotatably propels the oil into a hydrodynamically maintained somewhat wedge-shaped film at the bearing load zone Z. Again with reference to FIG. 1, oil escapes continuously from opposite ends of the gap 20 into inboard and outboard sumps 32, 34. From there, the oil is conveyed through filters and cooling devices (not shown) before being recirculated back to the bearing.

Until the advent of the present invention, it was conventionally thought that the oil escaping from opposite ends of the gap should be directed by gravity to the sumps 32, 34. To this end, the sumps and related drains were sized generously to ease gravitational flow.

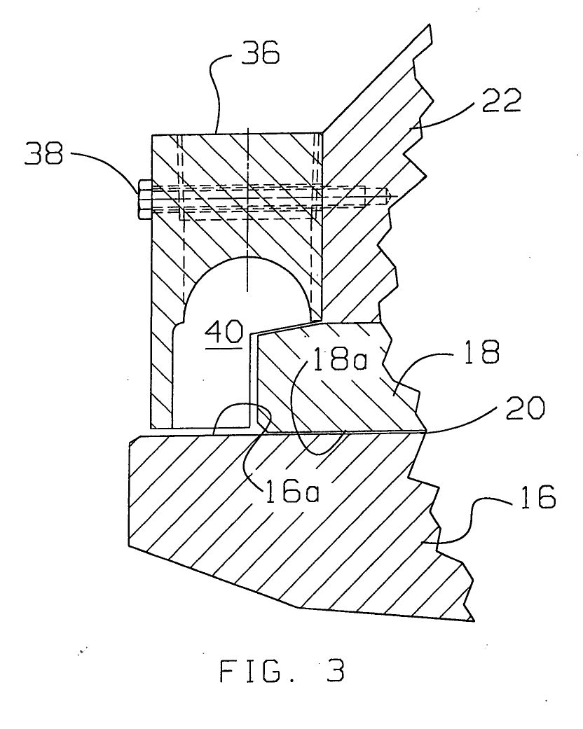

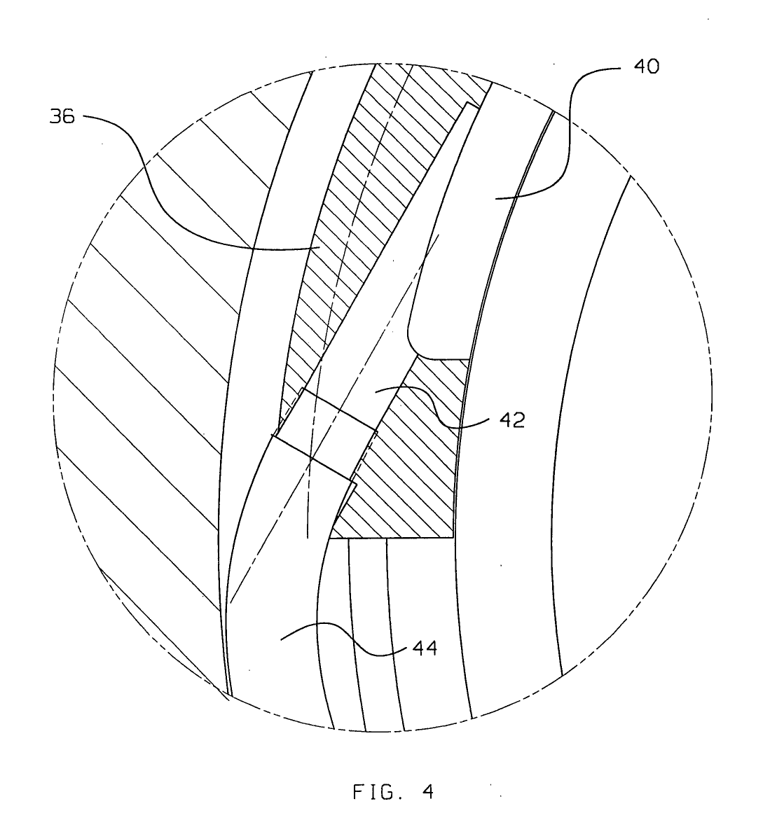

The present invention departs from this conventional approach by taking advantage of the discovery that the oil escapes tangentially from the gap 20 at a velocity directly proportional to the rotational speed of the journal surface 16a. In order to harness the kinetic energy of the escaping oil, semi-circular covers 36 are provided at at least one and preferably both ends of the gap 20. In the embodiment shown in FIGS. 1-4, the covers 36 are separable from and attached to the chock 22 or the bushing 18 by any convenient means, e.g., screws 38. Each cover 36 defines a semi-circular groove 40 arranged concentrically with respect to the rotational axis A of the roll at a location adjacent to an end of the gap 20. The groove 40 is positioned and configured to receive oil escaping tangentially from the gap 20 and to redirect the oil (see FIG. 2) along a circular path P in the direction R of rotation of the roll and its journal surface 16a. An exit passageway 42 communicates with the groove 40 at the end of the path P. The passageway is arranged substantially tangentially with respect to the path P to receive oil escaping from the groove 40. The exit passageway is connected by a flexible hose 44 or the like to a drain passageway 46 that preferably bypasses the sumps 32, 34.

It thus will be seen that in effect, the kinetic energy of the oil escaping tangentially from the gap 20 is harnessed and employed to efficiently pump oil from the bearing via the groove 40 and its associated exit passageway 42. By bypassing the sumps 32, 34 with the exiting oil, the size of the sumps can be beneficially reduced, with a corresponding reduction in the size and cost of the chock 22.

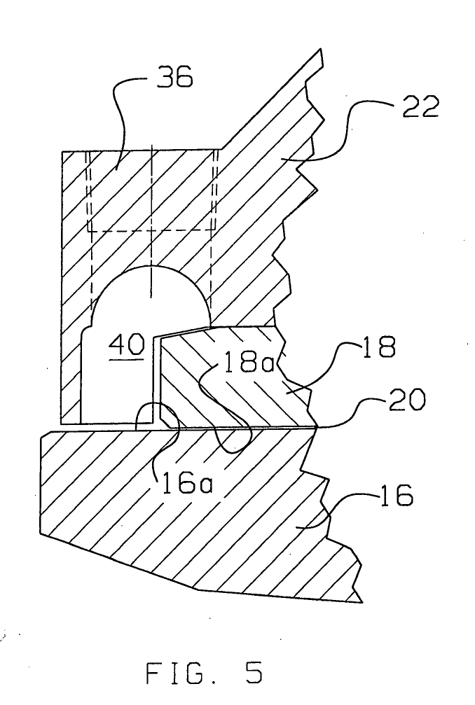

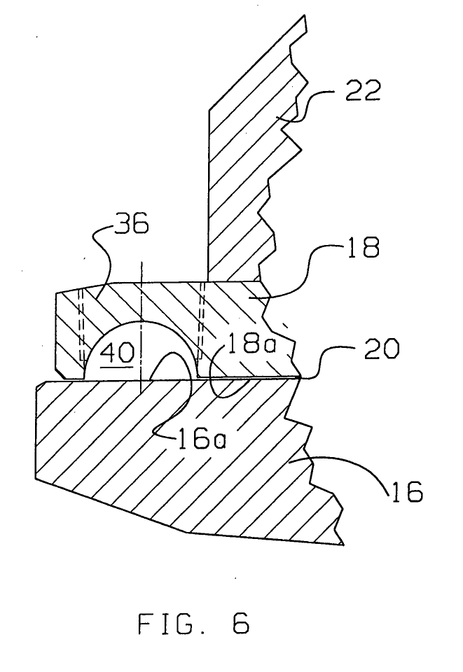

FIG. 5 illustrates an alternative embodiment of the invention in which the cover 36 is formed as an integral extension of the chock 22. Still another embodiment is shown in FIG. 6 where the cover 36 is formed as an integral extension of the bushing 18.

In light of the foregoing, those skilled in the art will understand that various changes and modifications can be made to the embodiments herein disclosed without departing from the basic concepts of the invention. For example, where the rolls have cylindrical as opposed to tapered neck sections, sleeves can be omitted, in which case the journal surfaces of the bearings are defined by the surfaces of the roll necks.

1. An oil outlet for a rolling mill oil film bearing in which a bushing is fixed within a chock, the bushing has an internal bearing surface surrounding a rotating journal surface of a roll, oil is introduced into a gap between the journal and bearing surfaces, and the thus introduced oil is rotatably propelled by the rotating journal surface before escaping tangentially from opposite ends of said gap, said oil outlet comprising:
a cover defining a groove adjacent to an end of said gap, said groove being positioned and configured to receive oil escaping from said gap and to redirect said oil along a circular path; and
an exit passageway communicating with said groove, said passageway being arranged substantially tangentially with respect to said circular path to receive oil escaping from said groove.

2. The oil outlet of claim 1 wherein said cover comprises a fixture separable from and attached to said chock.

3. The oil outlet of claim 1 wherein said cover comprises an integral extension of said bushing.

4. The oil outlet of claim 1 wherein said cover comprises an integral extension of said chock.

5. The oil outlet of claim 1 wherein a cover and its associated exit passageway is provided at opposite ends of said gap.

6. The oil outlet of claim 1 further comprising means for connecting said exit passageway to a drainage sump.

7. The oil outlet of claim 1 wherein said groove extends approximately 180° around said path.
